(19) United States
(12) Patent Application Publication
(10) Pub. No.: US 2006/0106615 A1
(43) Pub. Date: May 18, 2006

(54) Speech interaction apparatus and speech interaction method

(75) Inventors: Masahiko Tateishi, Nagoya-city (JP); Katsushi Asami, Nukata-gun (JP); Toshiyuki Morishita, Nagoya-city (JP); Ichiro Akahori, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/257,106

(22) Filed: Oct. 25, 2005

(30) Foreign Application Priority Data
Nov. 17, 2004 (JP) 2004-333660

(51) Int. Cl. G10L 21/00

(52) U.S. Cl. 704/275

(57) ABSTRACT

A speech interaction apparatus starts pushing information to a user and executes a speech interaction about the information in a case where (i) an interaction starting condition for starting pushing the information is set and (ii) the interaction starting condition is satisfied. The speech interaction apparatus includes an interaction policy setting unit and a speech interaction unit. The interaction policy setting unit sets, in consideration of a drive route intended by the user, an interaction policy of certain information which satisfies an interaction starting condition. The speech interaction unit pushes the certain information and executes a speech interaction about the certain information in accordance with the interaction policy set by the interaction policy setting unit. This enables execution of a user-friendly speech interaction while maintaining safety during a drive.

### REFERENCE TO RELATED APPLICATIONS

This application is based on and incorporates herein by reference Japanese Patent Application No. 2004-333660 filed on Nov. 17, 2004.

### FIELD OF THE INVENTION

The present invention relates to a speech interaction apparatus and a speech interaction method.

### BACKGROUND OF THE INVENTION

Conventionally, an apparatus in which information is interactively provided to a user has been suggested (for example, see patent documents 1 and 2). A navigation apparatus disclosed in the patent document 1 actively provides information in accordance with situation by means of a speech interaction. In this apparatus, it is determined whether a condition for starting an information interaction is satisfied in accordance with, e.g., navigation information about a movement of a mobile body and user specific information about a usage history of a mobile body, and a speech is outputted to a user when this condition is satisfied.

In a navigation apparatus disclosed in the patent document 2, a language dictionary for recognition and a sound dictionary for recognition are changed in accordance with a workload of a user. When the workload is assumed to be high, each of a query response and a confirmation response is a single sentence. When the workload is low, a query response including multiple sentences or a query response including an implicit confirmation is used.

Patent document 1: JP-2003-329477A (U.S. Pat. No. 6,865,481 B2)

Patent document 2: JP-2003-108191A

In the navigation apparatus of the patent document 1, a condition for a speech interaction is not set in consideration of a drive route, e.g., set by a user. Accordingly, particularly when this navigation apparatus is used as, e.g., a guide book, a user may get the impression that a speech interaction starts suddenly. Additionally, an interaction starts even when a user gets tired, e.g., on a return route of a drive route and thus does not want to interact.

The navigation apparatus of the patent document 2 considers generation of a speech and a response when a user queries a speech interaction apparatus. However, a case where information is pushed, namely, a case where information is actively provided without a query of the user, is not considered. Accordingly, when there are many pieces of information provided from the speech interaction apparatus to the user, the user may not respond to the provided information because the information is pushed without considering a workload of the user.

Further, in both apparatuses of the patent documents 1 and 2, a current interaction cannot be suspended, and cannot be restarted at an appropriate timing.

### SUMMARY OF THE INVENTION

The present invention is achieved in view of the above problems. It is an object of the present invention to provide a speech interaction method and speech interaction apparatus for achieving a user-friendly speech interaction. It is another object of the present invention to provide a speech interaction method and speech interaction apparatus in which a speech interaction can be executed while maintaining safety during a drive.

To achieve the above objects, a speech interaction apparatus according to a first aspect of the present invention is provided with the following. The speech interaction apparatus starts pushing information to a user and executes a speech interaction about the information in a case where (i) an interaction starting condition for starting pushing the information is set and (ii) the interaction starting condition is satisfied. In the speech interaction apparatus, an interaction policy setting unit is included for setting, in consideration of a drive route intended by the user, an interaction policy of certain information which satisfies an interaction starting condition. Furthermore, a speech interaction unit is included for pushing the certain information and executing a speech interaction about the certain information, in accordance with the interaction policy set by the interaction policy setting unit.

The speech interaction apparatus of the present invention not only pushes information when an interaction starting condition is satisfied, but also sets an interaction policy of information which satisfies an interaction starting condition in consideration of a drive route intended by the user. Accordingly, for example, an interaction policy can be set so that information is pushed at an appropriate timing in accordance with a drive route. Therefore, a user does not get the impression that a speech starts suddenly. As a result, a user-friendly speech interaction can be achieved.

As another aspect of the present invention, a speech interaction apparatus is provided with the following. The speech interaction apparatus starts pushing information to a user and executes a speech interaction about the information. In the speech interaction apparatus, an object information detecting unit is included for detecting object information about at least one object of a sign, a board, and a building. A speech interaction unit is included for pushing certain information about the detected at least one object and executing a speech interaction about the certain information, when the object information detecting unit detects the object information.

Accordingly, a speech interaction of information about, e.g., signs, boards, and buildings detected by an object information detecting unit can be executed even in a case where the information is not included in previously provided information.

As another aspect of the present invention, a speech interaction apparatus is provided with the following. A speech interaction unit is included for pushing information to a user and for executing a speech interaction about the information. An interaction policy setting unit is included for setting an interaction policy that, when a speech for suspending a speech interaction under execution by the speech interaction unit and a speech for specifying a timing for restarting the speech interaction are made by a user, the speech interaction under execution is suspended, and the suspended speech interaction is restarted at the specified timing. Here, the speech interaction unit executes a speech interaction in accordance with an interaction policy set by the interaction policy setting unit.

Accordingly, for example, when a user cannot determine a specific request about an interaction item, a speech interaction can be prevented from being forcibly executed. Additionally, at a timing intended by the user, a speech interaction can be restarted. As a result, a specific request which could not be determined when a speech interaction was suspended can be determined at the restarting.

As another aspect of the present invention, a speech interaction apparatus is provided with the following. A speech interaction unit is included for pushing information to a user and executing a speech interaction about the information. An interaction policy setting unit is included for setting an interaction policy that, in a case where information to be pushed includes a plurality of items or sentences, when a predetermined time passes after one item or sentence is pushed, an item or sentence following the pushed item or sentence is pushed. Here, the speech interaction unit executes a speech interaction in accordance with an interaction policy set by the interaction policy setting unit.

For example, when information about a characteristic, charge, business hours, and so on of a tourist facility is successively pushed, a user may not memorize the pushed information. Additionally, for example, when an interaction with the user is executed using a synthesized speech, the user may not hear successively pushed items and sentences because the synthesized speech is sometimes unclear. To avoid the above problems, information is pushed at specific intervals.

As another aspect of the present invention, a speech interaction apparatus is provided with the following. A speech interaction unit is included for pushing information to a user and executing a speech interaction about the information. An interaction policy setting unit is included for setting an interaction policy that a speech interaction of information which introduces a speech interaction function is executed at a preset timing. Here, the speech interaction unit executes a speech interaction in accordance with an interaction policy set by the interaction policy setting unit.

Accordingly, for example, at an approach of an expressway, a speech interaction function (for example, guiding to a nearest service area) in a case where a user feels tired and sleepy can be introduced.

As another aspect of the present invention, a speech interaction apparatus is provided with the following. The speech interaction apparatus starts pushing information to a user and executes a speech interaction about the information in a case where (i) an interaction starting condition for starting pushing the information is set and (ii) the interaction starting condition is satisfied. In the speech interaction apparatus, a usage history managing unit is included for setting an interaction starting condition relating to a usage history with respect to information, and for managing the usage history of the information based on an execution of a speech interaction about the information; further, a speech interaction unit is included for pushing certain information having no usage history and for executing a speech interaction about the certain information.

Accordingly, when a user moves on the same drive route as a previous route, information about the previous route can be prevented from being pushed.

As another aspect of the present invention, a speech interaction apparatus is provided with the following. A speech interaction unit is included for pushing information to a user and executing a speech interaction about the information. Further, an interaction policy setting unit is included for setting an interaction policy as follows: in a case where there is no speech of response to suggestion information even when a response waiting time passes after the speech interaction unit pushes the suggestion information to a user, a speech interaction of an additional explanation for the suggestion information or a speech interaction of different suggestion information from the suggestion information is executed. Here, the speech interaction unit executes a speech interaction in accordance with an interaction policy set by the interaction policy setting unit.

When there is no speech of response to suggestion information, it is assumed that a user cannot determine on the suggestion because provided information is insufficient, or that the user requests another suggestion because the suggestion information is not appropriate. Therefore, an additional explanation of the suggestion information and/or a speech interaction of different suggestion information are executed, so that a user can easily determine on the suggestion, or a different suggestion intended by the user can be made.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing an overall structure of a navigation apparatus of an embodiment of the present invention;

FIG. 2 is a functional block diagram of a control circuit;

FIG. 3 is a diagram explaining guidance information;

FIG. 4A is a diagram explaining information about buildings under construction;

FIG. 4B is a diagram explaining information about function introduction;

FIG. 5 is a diagram explaining rules 1 to 4 in accordance with a drive route;

FIG. 6 is a diagram explaining a rule (rule 4) for pushing information at time intervals when there are a plurality of pieces of information at a point;

FIG. 7 is a diagram explaining a rule (rule 5) for suspending a current interaction, and specifying a timing for restarting the interaction;

FIG. 8 is a diagram explaining a rule (rule 6) for reading speeches at time intervals when there are many pieces of information to be pushed;

FIG. 9 is a diagram explaining a rule (rule 7) for introducing a speech interaction function at an appropriate timing;

FIG. 10 is a diagram explaining a rule (rule 9) in a case where a user does not respond;

FIG. 11 is a flowchart showing an interaction policy setting process for setting an interaction policy in accordance with the rules 1 to 4, 7, and 8;

FIG. 12 is a flowchart showing an interaction policy setting process for setting an interaction policy in accordance with the rule 5;

FIG. 13 is a flowchart showing an interaction policy setting process for setting an interaction policy in accordance with the rule 6;

FIG. 14 is a flowchart showing an interaction policy setting process for setting an interaction policy in accordance with the rule 9;

FIG. 15 is an image when pieces of information (b) to (d) are placed on a drive route; and

FIG. 16 is an image when a piece of information (a) is placed on a drive route.

### DETAILED DESCRIPTION OF THE PREFERRED EMBODIMENTS

A speech interaction apparatus and speech interaction method of the present invention are explained below in reference to the drawings. In this embodiment, an example in which the speech interaction apparatus and speech interaction method of the present invention are used as a function of a navigation apparatus mounted in a subject vehicle such as an automobile is explained.

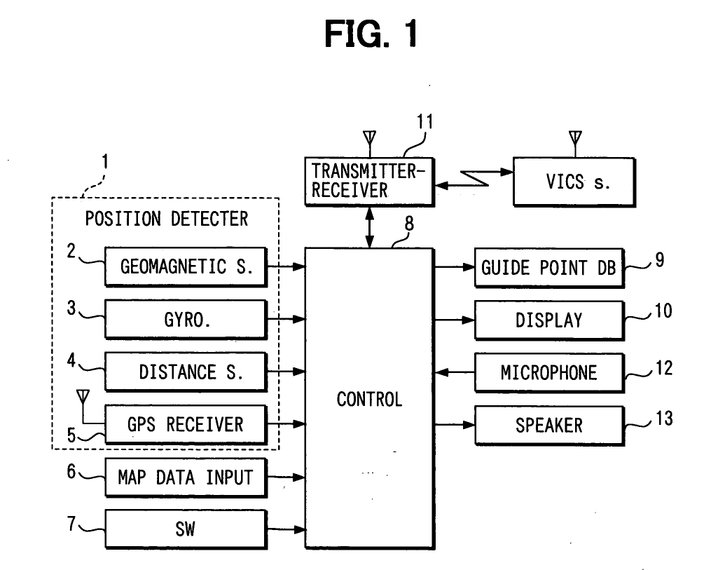

FIG. 1 is a block diagram showing an overall structure of the navigation apparatus. As shown in FIG. 1, the navigation apparatus includes a position detector 1, a map data input device 6, an operation switch group 7, a control circuit 8, a guide point database (hereinafter called a guide point DB) 9, a display device 10, a transmitter-receiver 11, a speech input microphone 12, a speaker 13, a remote control sensor (not shown), and a remote controller (not shown).

The control circuit 8 is structured as a normal computer, and includes a known CPU, ROM, RAM, and I/O, and, e.g., a bus line which connects these components. A program executed by the control circuit 8 is written in the ROM. In accordance with the program, the CPU and so on execute predetermined operations.

The position detector 1 has a geomagnetic sensor 2 for detecting a traveling direction of the subject vehicle, a gyroscope 3 for detecting an angular speed around a vertical direction of the subject vehicle, and a distance sensor 4 for detecting a movement distance of the subject vehicle, and a GPS receiver 5 for GPS (Global Positioning System) for detecting a current position of the subject vehicle in accordance with radio waves from satellites. Since these sensors have errors having different characteristics, the sensors complement each other.

In accordance with an accuracy of each sensor, the position detector 1 may have part of the above sensors. Additionally, the position detector 1 may have, e.g., a steering rotation sensor (not shown) and a vehicle speed sensor (not shown) for detecting a speed from a rotation speed of each wheel.

The map data input device 6 inputs map data including road data, index data, and drawing data. To store the map data, storage media such as CD-ROMs and DVD-ROMs and rewritable storage media such as memory cards and hard disk are used. Link data and node data structuring road data, index data, and drawing data are explained below.

First, a link means a road between nodes. Each road on the map is divided at nodes such as intersections, branches, and meeting points. By connecting the links, roads are structured. The link data includes an identification number (link ID) for identifying a link, a link length showing a length of a link, coordinates (latitudes, longitudes) of a start and end of a link, a name of a road, a type of a road (such as an expressway, a toll road, a national road, and a prefecture road), a road width, a time required for traveling a link (traveling time by walk and traveling time using an automobile), and so on.

The node data includes a node ID which is a unique number provided to each node where each road on the map intersects, branches, and meets, a node coordinate (latitude, longitude), a connection link ID in which link IDs of all links connected to a node are described, and an attribute and name of a node (for example, a name of an intersection of a general road and a name of an interchange (IC), a junction (JCT) of an expressway or toll road), the attribute showing whether a node is a branch, a junction, or an intersection.

The index data is used for retrieving, e.g., buildings, and includes, e.g., names, types, addresses, phone numbers, positions (latitudes, longitudes) of buildings, roads, and points where roads intersect, branch, and meet.

The drawing data is used for displaying maps, and includes display characters, display positions (latitudes, longitudes), polygon data, and marks (such as landmarks), with respect to landforms (e.g., seas, lakes, ponds, and mountains), facilities, roads, and points where roads branch, meet, and intersect.

The operation switch group 7 uses, e.g., a touch switch integrated with the display device 10 or a mechanical switch, and is used for various inputs.

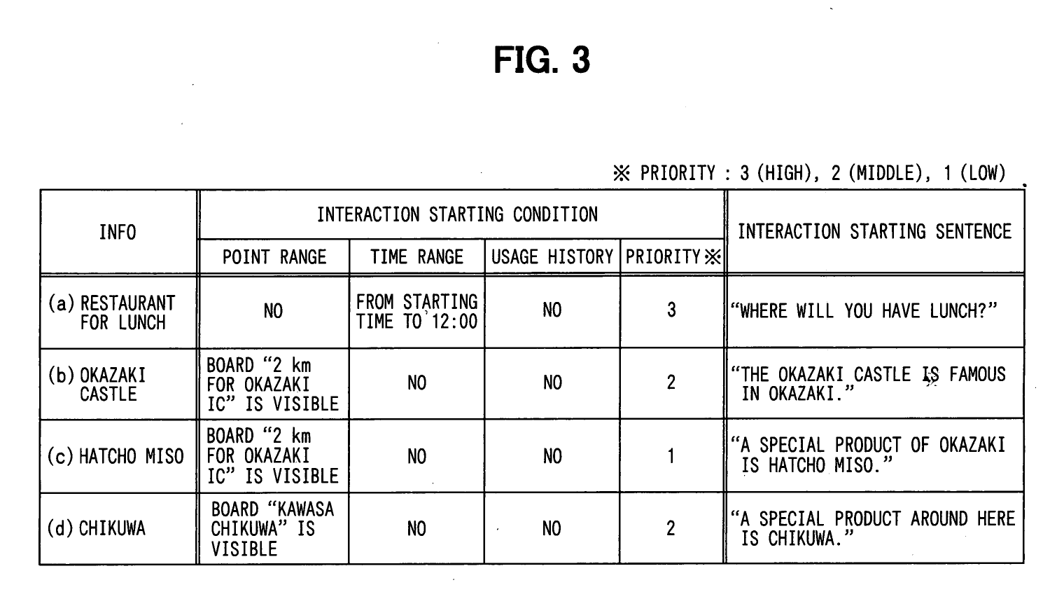

The guide point DB 9 stores guidance information used for speech interactions. In the guidance information, as shown in FIG. 3, interaction starting conditions (relating to a point range, a time range, a usage history, and a priority) are set in each piece (a), (b), (c), and (d) of information. An interaction starting sentence is set in each piece of the information. Accordingly, points (places), times, histories, priorities, and so on can be used for interaction starting conditions.

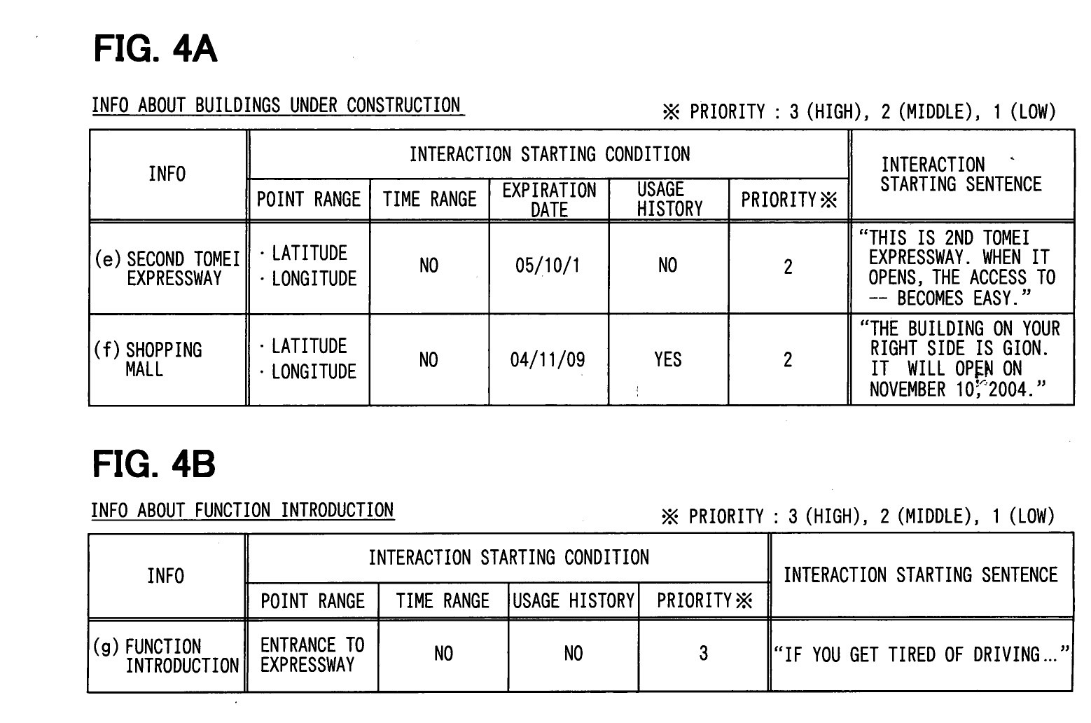

As shown in FIGS. 4A, 4B, the guide point DB 9 stores information about incomplete buildings under construction and information for introducing functions as guidance information. Interaction starting conditions for pieces (e), (f) of information about the buildings under construction are set with respect to, point ranges, time ranges, usage histories, priorities, and expiration dates.

Interaction starting conditions of information (g) about a function introduction are the same as those of the pieces of the information (a) to (d) shown in FIG. 3.

The display device 10 includes, e.g., a liquid crystal display. The display device 10 displays on its screen (i) a vehicle position mark corresponding to a current position of the subject vehicle inputted from the position detector 1, and (ii) a road map around the subject vehicle generated using map data inputted from the map data input device 6.

The transmitter-receiver 11 communicates with the outside of the subject vehicle, and receives update data of guidance information to be stored in the guide point DB 9 from an external information center. The transmitter-receiver 11 is connected, via beacons mounted on roads and FM broadcast stations, to a VICS sensor for receiving road traffic information provided from a VICS (Vehicle Information and Communication System) (registered trademark) center, and transmits this road traffic information to the control circuit 8.

Road traffic information received by this VICS sensor includes, e.g., traffic congestion information such as a traffic congestion of each link and a required traveling time of each link, regulation information about roads closed due to accidents and construction works and about closures of interchanges of expressways, and traffic density information showing traffic density (high, middle, low). The received road traffic information is processed in the control circuit 8. For example, the traffic congestion information and regulation information can be displayed over a road map displayed on the screen of the display device 10.

The speech input microphone 12 receives a speech inputted by a user, converts it to speech signals, and outputs them to the control circuit 8. When a speech is inputted, by pressing, e.g., a button of a talk switch (not shown), an input trigger signal is transmitted to the control circuit 8. The control circuit 8 receives the input trigger signal to start receiving a speech inputted through the speech input microphone 12.

The speaker 13 is used for providing various information to a user of the navigation apparatus by means of a speech. The speaker 13 may be, e.g., a speaker mounted in the subject vehicle or a speaker installed in the navigation apparatus.

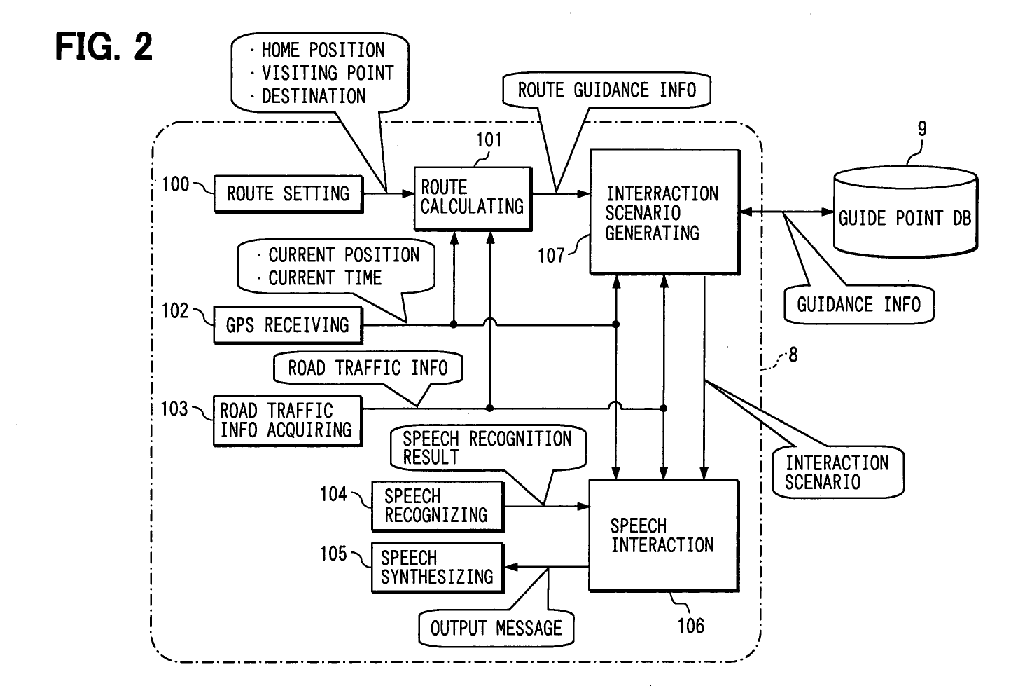

FIG. 2 shows a function block diagram of the control circuit 8. As shown in FIG. 2, the control circuit 8 includes, as main functions, a route setting unit 100, a route calculating unit 101, a GPS receiving unit 102, a road traffic information acquiring unit 103, a speech recognizing unit 104, a speech synthesizing unit 105, a speech interaction unit 106, an interaction scenario generating unit 107, and so on.

The route setting unit 100 sets a destination, visiting points (or passing points) before arrival at the destination, and a starting point (such as a home position and a current position) in accordance with operations of, e.g., the remote controller and the operation switch group 7, or with, e.g., a speech input from a speech input microphone 12.

The route calculating unit 101 automatically calculates an optimum route of a drive route (from the starting point to the destination through the visiting points) set by the route setting unit 100. The Dijkstra method is one of known methods for setting an optimum route.

The route calculating unit 101 outputs route guidance information about a calculated route to the interaction scenario generating unit 107. The route calculating unit 101 can calculate a drive route including an outward route and a return route. The outward route is from the starting point to the destination through the visiting points. The return route is from the destination to the starting point.

The GPS receiving unit 102 receives information about, e.g., a current position and a current time. The road traffic information acquiring unit 103 acquires road traffic information transmitted from the transmitter-receiver 11.

The speech recognizing unit 104 includes, e.g., an analog-to-digital conversion circuit, a recognition program processing unit, a sound model storing unit, and a recognition dictionary storing unit. These components are not shown. The analog-to-digital conversion circuit receives a speech signal inputted via the speech input microphone 12, and converts this signal to a digitalized signal. The converted digital speech signal is transmitted to the recognition program processing unit.

The recognition program processing unit converts a digital signal to recognition words by use of the sound model storing unit and the recognition dictionary storing unit. For example, the recognition program processing unit analyzes a speech (reading of recognition words) corresponding to a digital speech signal by means of, e.g., the known Hidden Markov Model. This analyzed reading of the recognition words is checked with recognition words stored in the recognition dictionary storing unit, and the most certain recognition words are extracted. These extracted words are outputted to the speech interaction unit 106 as the speech recognition result.

The speech synthesizing unit 105 receives a message (output message) that is to be outputted via the speaker 13, from the speech interaction unit 106. The unit 105 then generates a synthesized speech corresponding to the content of the message.

The speech interaction unit 106 is a control unit for executing an interaction with a user. The speech interaction unit 106 acquires, from the interaction scenario generating unit 107, an interaction scenario appropriate for a speech recognition result from the speech recognizing unit 104. The speech interaction unit 106 outputs an output message in accordance with the acquired interaction scenario to the speech synthesizing unit 105.

Even when the speech recognizing unit 104 does not output a speech recognition result, the speech interaction unit 106 acquires an interaction scenario from the scenario generating unit 107 in accordance with an interaction policy set by the scenario generating unit 107. Then, the speech interaction unit 106 outputs an output message in accordance with the scenario to the speech synthesizing unit 105.

The interaction scenario generating unit 107 actively provides (hereinafter called “pushes”) information to a user, generates an interaction scenario for executing a speech interaction about the information, and sets the interaction policy. Guidance information needed for the interaction is acquired from the guide point DB 9.

The navigation apparatus of this embodiment including the above structure pushes information to a user, and executes a speech interaction process which executes a speech interaction about the information. The navigation apparatus not only pushes information when the above interaction starting condition is satisfied, but also sets an interaction policy of information which satisfies an interaction starting condition in consideration of a drive route intended by the user.

The navigation apparatus pushes information which satisfies an interaction starting condition in accordance with this set interaction policy, and executes a speech interaction about the information. This results in achieving the user-friendliness and safety.

Next, a feature of the navigation apparatus of this embodiment is explained. The navigation apparatus of this embodiment executes an interaction policy setting process for setting an interaction policy in accordance with previously set rules (rules 1 to 9). The rules 1 to 4 are in accordance with a drive route. The rule 5 is in accordance with a convenience of a user. The rule 6 is for the case when many pieces of information are pushed. The rule 7 is in consideration of user-friendliness. The rule 8 is about a usage history of each user. The rule 9 is for the case when a user does not respond. (Rules 1 to 4: in accordance with a drive route) The rules 1 to 4 are in accordance with a drive route intended by a user, and include the rule when an expressway is used on an outward route (rule 1), the rule for a point where, e.g., a sign, a board, or a building is visible (rule 2), the rule on a return route (rule 3), and the rule when there are a plurality of pieces of information for a point (rule 4).

Rule 1: when an expressway is used on an outward route

The rule 1 is that, when an expressway is used on an outward route, information which can be previously processed is pushed during a drive on the expressway. Since a workload of a user on an expressway is usually lower than a workload on a general road, a speech interaction is easily executed on the expressway. Therefore, on an expressway where a workload is relatively low, information which can be previously processed is pushed, so that a speech interaction can be executed while maintaining safety during a drive.

On a general road where there are few signals and thus a traffic flow is smooth, a workload is low as well as on an expressway. In this sense, the expressway in this embodiment includes a general road where a workload is low.

An example of this rule 1 is as follows. A drive route is first grasped in accordance with route guidance information. Premises of the rule are that the drive route includes an outward route and a return route, that the outward route includes an expressway, and that there is guidance information which satisfies the interaction starting conditions shown in FIG. 3 on both a section of the expressway and a section of the drive route after passing through the expressway. Since the information needs to be previously processed, a first destination needs to be determined at the time of leaving the expressway. Information which satisfies these premises is placed on the expressway on the drive route.

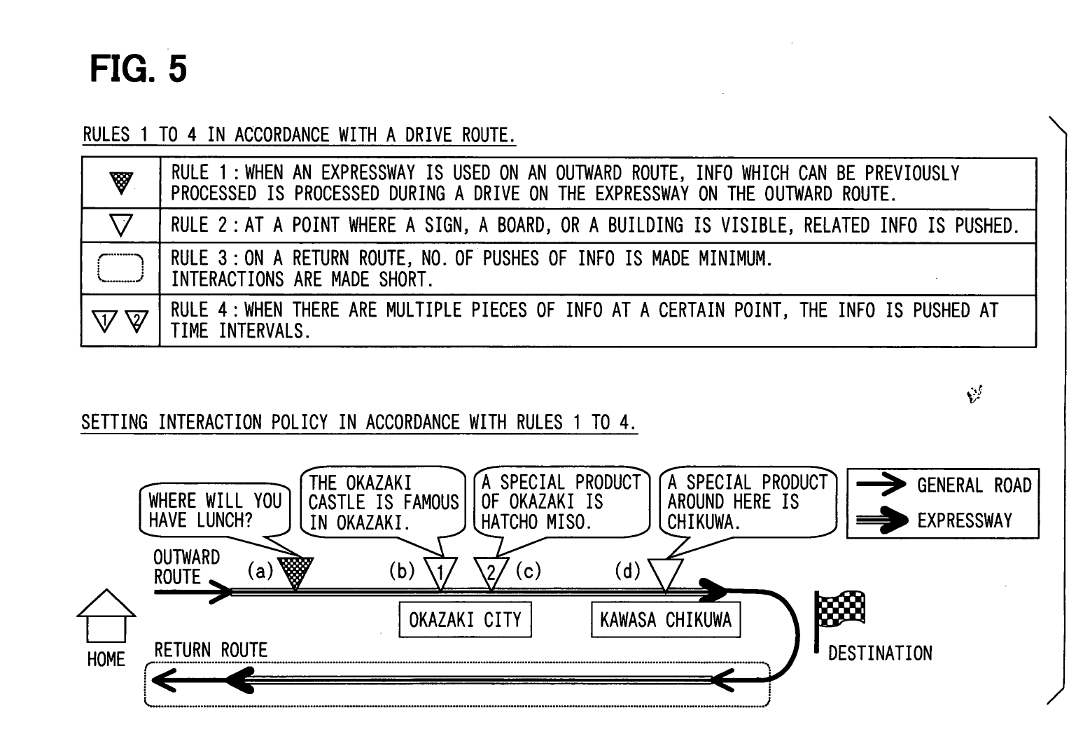

For example, as shown in FIG. 5, an expressway is used on the outward route, on a drive route including an outward route from a home to a destination through Okazaki City and a return route from the destination to the home. Accordingly, the piece of the information (a) which is shown in FIG. 3 and can be previously processed is placed on this expressway.

When an expressway includes a section where a traffic density is high and a workload is high, only information in which a priority of equal to or over a certain value (for example, equal to or over two) is set as the interaction starting condition may be placed. Accordingly, a speech interaction in a state that a workload is high can be avoided to the utmost. The information may be placed on a section except a section where a workload is high, or on a section where a workload is low on a general road used on an outward route.

For instance, a road section where a traffic density shown by the above road traffic information is high may be specified as the section where a workload of a user is high.

Rule 2: at a point where a sign, a board, a building, or the like is visible

The rule 2 is that, at a point where a sign, a board, or a building is visible, the related information is pushed. At a point where a user can see a sign, a board, or a building, information about that is pushed, so that the user does not get the impression that a speech interaction is suddenly started. The information is pushed at such an appropriate timing, so that signs, boards, buildings, and so on are effectively advertised.

In detail, in this rule 2, as well as in the rule 1, a drive route is first grasped. Guidance information which satisfies the interaction starting condition of the point range shown in FIG. 3 on this drive route is extracted, and placed on the drive route. For example, the pieces of the information (b) to (d) are placed on the drive route shown in FIG. 5.

At a point where a sign “2 km for Okazaki IC” is visible, interactions about sightseeing such as “The Okazaki Castle is famous in Okazaki” and “A specialty of Okazaki is Hatcho Miso” are executed. At a point where a board “Kawasa Chikuwa” is visible, interactions about noted local products such as “A specialty around here is Chikuwa” or about advertisement are executed. (Here, “Miso” is a Japanese word indicating fermented soybean pastes, while “Chikuwa” is a Japanese word indicating a fish sausage.)

Buildings of the rule 2 may include incomplete buildings, e.g., under construction. Since a user tends to be strongly interested in incomplete buildings, e.g., under construction, information about incomplete buildings is pushed to enhance availability of the speech interaction apparatus.

As described above, the information about buildings includes incomplete buildings, e.g., under construction, so that, for example, in the guidance information (e) of FIG. 4A, at a point where a construction site of the second TOMEI expressway is visible, road information such as “This is the second TOMEI expressway. When it is opened, the access to—becomes easy.” can be pushed.

As shown in FIG. 4A, this information about incomplete buildings may be set while including an expiration date as an interaction starting condition. Accordingly, information about incomplete buildings having an invalid expiration date can be prevented from being pushed. The information having an invalid expiration date may be deleted from the guidance point DB 9.

Even if information about a building under construction has a usage history, the information having an expiration date may be pushed. Accordingly, information about an incomplete building in which a user was previously interested can be repeatedly pushed. The above related information is such that the latest information about an incomplete building is acquired from the outside via the transmitter-receiver 11, and pushed.

For example, in the guidance information (f) of FIG. 4A, information such as “A building on your right side is Gion. It will open on Nov. 11, 2004.” is pushed when the guidance information has no usage history and is first pushed. At the second time when one week remains until the open of the building, the latest information such as “one week remains until the open of Gion.” At the third time, the latest information such as “Gion has opened today, November 11. The grand opening sale is now in progress.” is pushed.

Rule 3: a rule on a return route

The rule 3 is that the number of interactions is made minimum, and that the interactions are made short. Since a user often gets tired on a return route (or homeward route), the user does not actively interact. When an outward route and return route are the same, an interaction of the same information as that for the outward route does not need to be executed on the return route.

Therefore, with respect to the return route, among information having no usage history, low-priority information about, e.g., sightseeing, specialties, and native products is not pushed, but only high-priority information (equal to or over a certain value) of information is pushed. Accordingly, an effective speech interaction can be executed.

Rule 4: when there are multiple pieces of information at a point

The rule 4 is that when there are multiple pieces of information at a point, information is pushed at time intervals. When a user receives many pieces of information at once, the user often cannot respond to them. In a case where there are multiple pieces of information which satisfy an interaction starting condition of the same point range on a drive route, information is pushed as follows. When a predetermined time passes after an interaction about one piece of information is pushed, another piece of information is pushed, as long as an interaction starting condition of each piece of information is satisfied.

As described above, instead of providing many pieces of information to a user at once, when a predetermined time passes after an interaction about one piece of information, another piece of information is pushed, so that the user can grasps provided information. Information may be pushed at equal time intervals as long as a response starting condition is satisfied. As a result, a time during which no interaction is executed can be prevented from being prolonged.

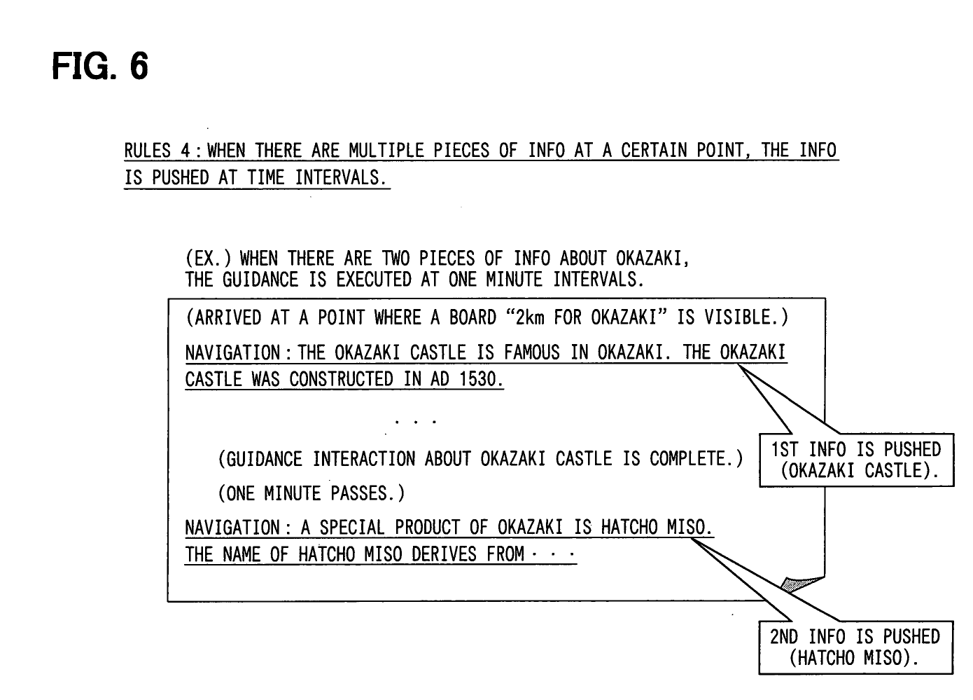

For example, as shown in FIG. 3, when the above-described pieces of the information (b) and (c) have the same interaction starting condition of the point range, the second piece of information about Hatcho Miso is pushed one minute after the first interaction about Okazaki Castle is completed, as shown in FIG. 6. The pieces of the information (b) and (c) are pushed in descending order of the priority.

As described above, by setting interaction policies of the rules 1 to 4 in accordance with a drive route, guidance information shown in FIG. 5 is placed on the drive route. Next, rules 5 to 9 except the rules in accordance with a drive route are explained.

Rule 5: in accordance with convenience of a user

The rule 5 is that a current interaction can be suspended, and a timing for restarting the interaction can be specified. When an interaction is forcibly executed at the time when a user cannot determine a specific request about an interaction, the user can be discouraged from using a speech interaction.

When a speech for suspending a current speech interaction is made, the speech interaction is suspended. Accordingly, for example, a speech interaction can be prevented from being forcibly executed at the time when a user cannot determine a specific request about an interaction.

When a speech about a timing for restarting a speech interaction is made at the same time as a speech for suspending the speech interaction, the suspended speech interaction can be restarted at the specified timing. Accordingly, a speech interaction can be restarted at a timing intended by a user. As a result, a request which could not be determined when a speech interaction was suspended can be determined when the speech interaction is restarted.

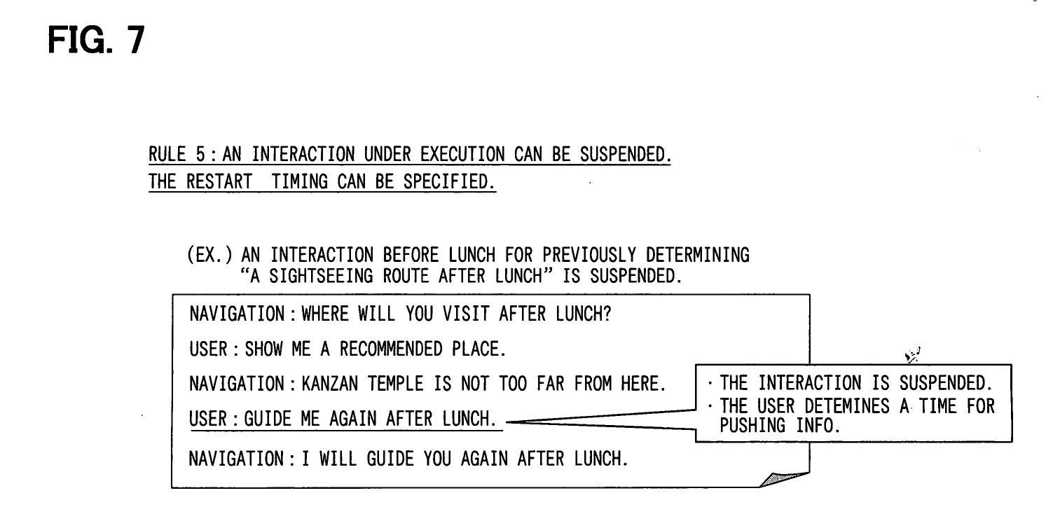

In the example shown in FIG. 7, a speech “after meal” means a timing for restarting a speech interaction, and a speech “guide me later” means a timing for suspending an interaction.

Rule 6: when there are many pieces of information to be pushed

The rule 6 is that, when there are many pieces of information to be pushed to a user, speeches are made at time intervals. For example, when information about characteristics, fee, and business hours of a sightseeing facility is successively pushed, a user may not memorize the pushed information. For example, when a user interacts with a synthesized speech, the user may not hear the successively pushed items and sentences because the synthesized speech is not clear.

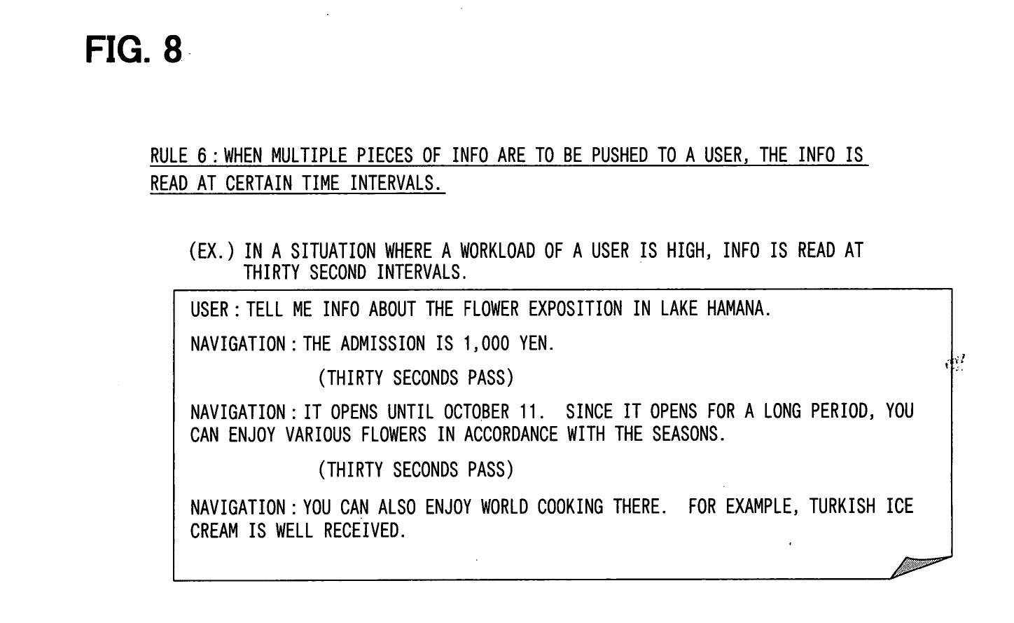

In a case where information to be pushed includes multiple items or sentences, when a predetermined time (for example, thirty seconds in the example of FIG. 8) passes after an item or sentence is pushed, an item or sentence following the pushed item or sentence is pushed. Accordingly, the above-described problems can be prevented. In accordance with the above-described workload of a user, the predetermined time may be changed. Accordingly, a time interval can be changed in accordance with a workload of a user.

Rule 7: in consideration of user-friendliness

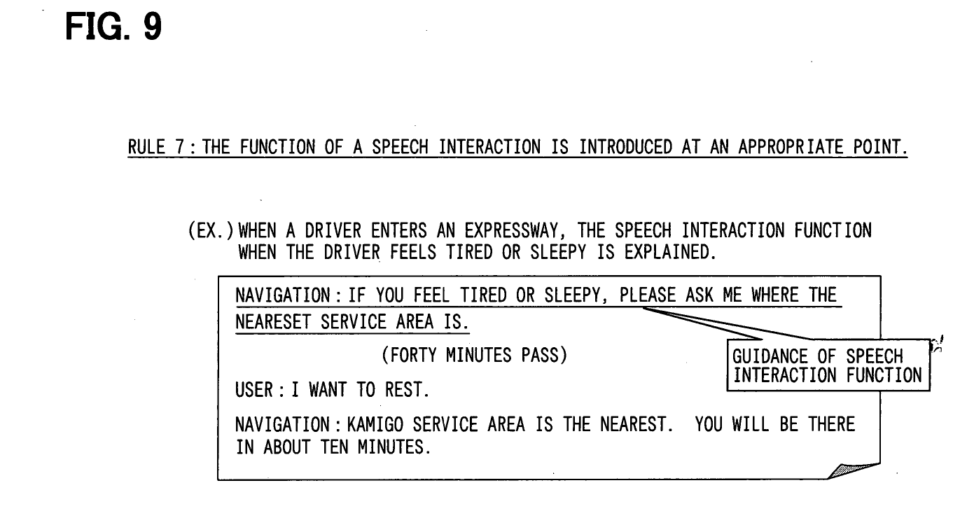

The rule 7 is that a speech interaction function is introduced at an appropriate timing. For example, as information for introducing functions shown in FIG. 4B, an entrance of an expressway is set as an interaction starting condition relating to a point range. Accordingly, as shown in FIG. 9, at an approach to an expressway, a speech interaction function (for example, for guiding to a nearest service area) when a user feels tired or sleepy can be introduced.

Rule 8: about a usage history of each user

The rule 8 is that a usage history of each user is managed, and information having a usage history is not pushed to a user who uses a navigation apparatus. In a case where a user moves on the same drive route as the previous one, when the previously pushed information is pushed again, the user may feel it to be annoying.

Therefore, a usage history of each user is managed, and information having no usage history is pushed to a user who uses the navigation apparatus. Accordingly, when a user moves on the same drive route as the previous one, previously pushed information can be prevented from being pushed again.

To manage a usage history of each user, a user needs to be specified. To specify a user, known user certification processes using a face image, living body information, speech information, a password, and so on may be executed.

In the rule 8, for example, since traffic information and weather information always change, usage histories of the information are not managed. Namely, a usage history corresponding to time varying information which always varies is not managed. Accordingly, the time varying information can be pushed repeatedly.

Rule 9: rule when a user does not respond

The rule 9 is that when a user does not respond to a suggestion, an additional explanation of the suggestion (or another suggestion) is made. Namely, when there is no speech in response to suggestion information, it is assumed that a user cannot determine the suggestion because provided information is insufficient, or requests another suggestion because the suggestion is not appropriate.

In such a case, an additional explanation of the suggestion or a speech interaction of another suggestion information are made. A user thereby easily determines the suggestion. Alternatively, another suggestion is thereby made which is assumed to follow the intention of user.

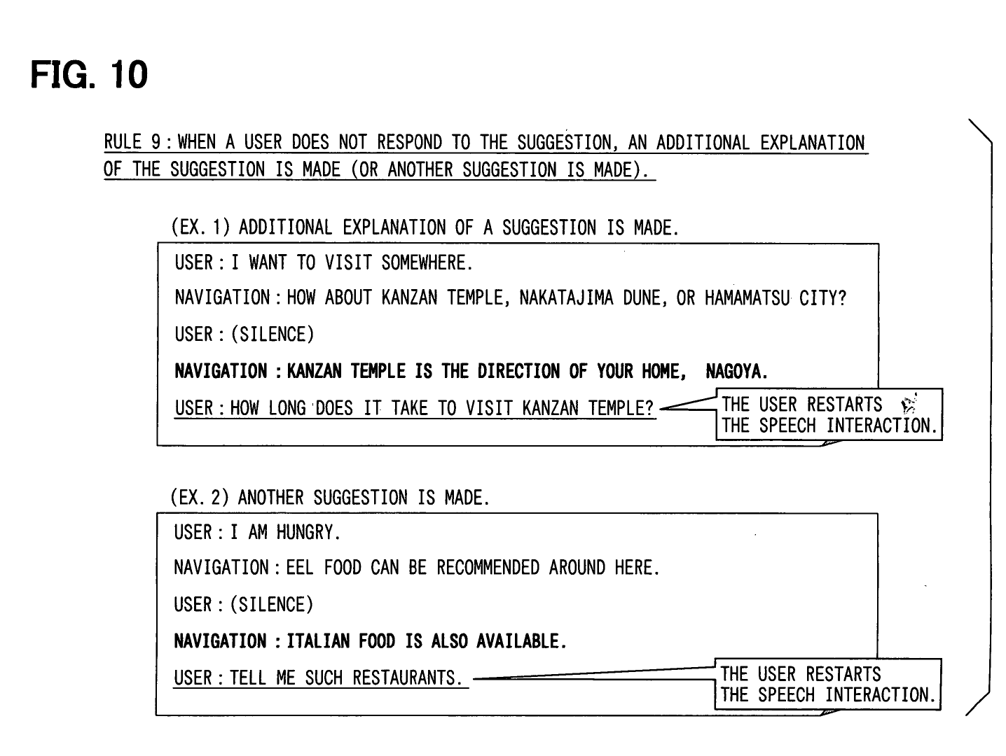

For example, like the content of the interaction shown in the example 1 of FIG. 10, when a user is silent, an additional explanation of the information outputted before the silence is made. It can be expected that the user restarts a speech interaction in response to the additional explanation. Like the content of the interaction shown in the example 2 of FIG. 10, when a user is silent, a suggestion different from the information outputted before the silence is made. It can be expected that the user restarts a speech interaction in response to the different suggestion.

As described above, the interaction policy setting processes for setting interaction policies in accordance with the rules 1 to 9 are divided into the rules which can be set after a drive route is determined and the rules which are set in accordance with, e.g., a workload and speech content of a user during a speech interaction process.

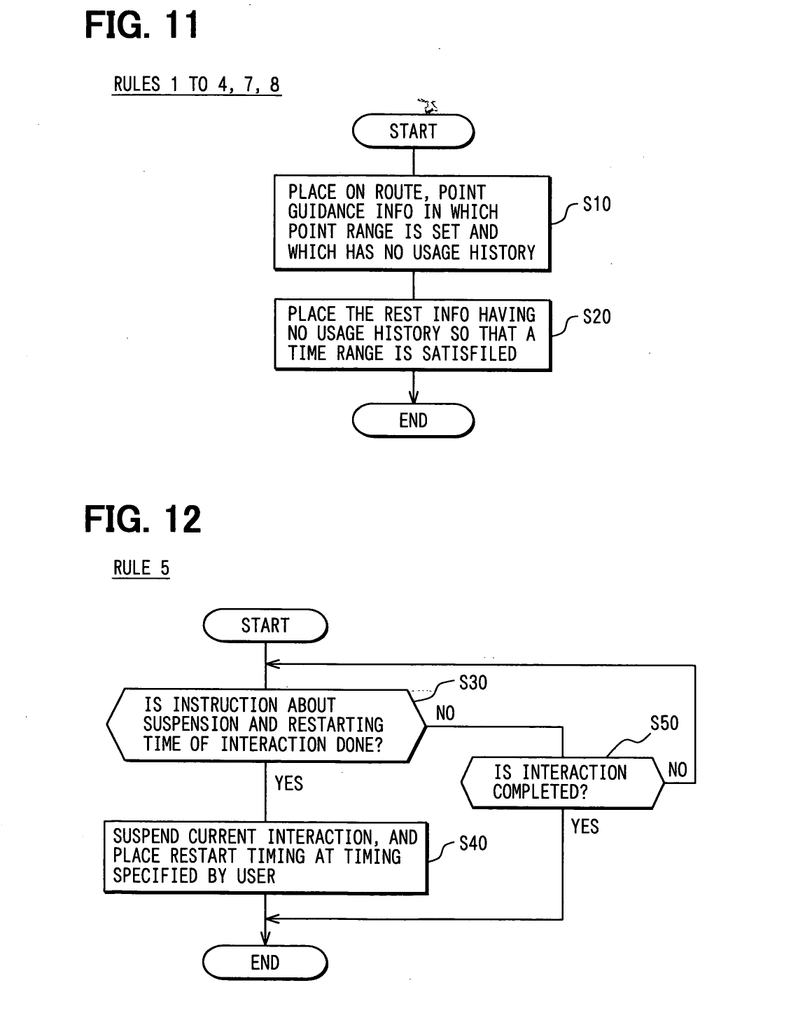

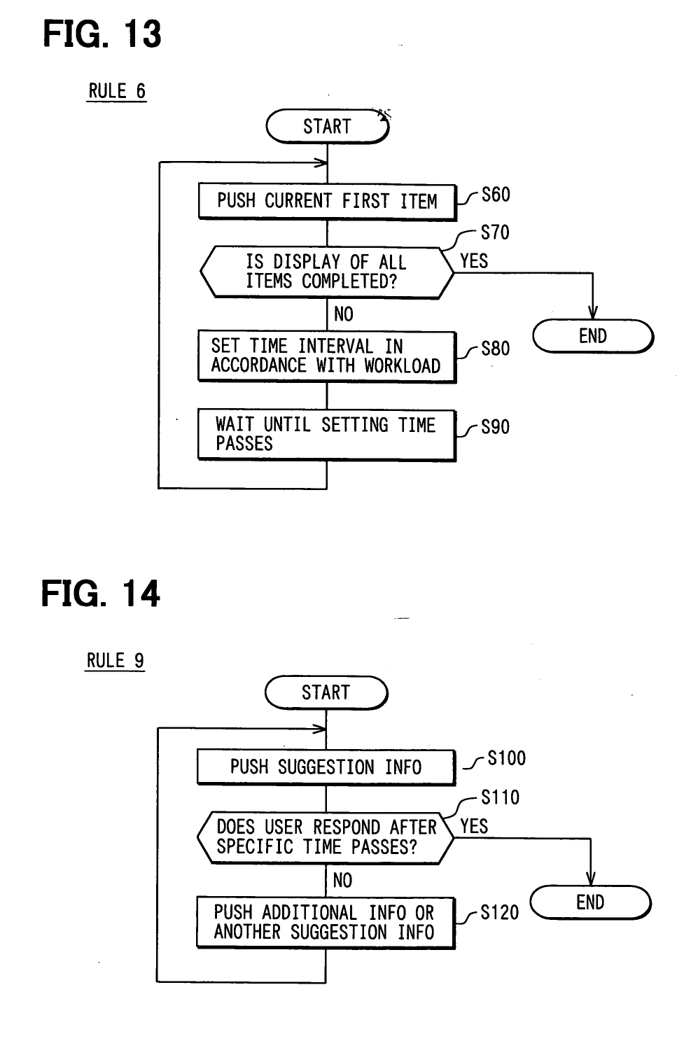

Next, interaction policy setting processes in the navigation apparatus of this embodiment are explained using flowcharts shown in FIGS. 11 to 14. FIG. 11 shows processes of the rules 1 to 4, 7, and 8. FIG. 12 shows a process of the rule 5. FIG. 13 shows a process of the rule 6. FIG. 14 shows a process of the rule 9.

First, an interaction policy setting process in accordance with the rules 1 to 4, 7, and 8 is explained. In Step 10 shown in FIG. 11, guidance information that satisfies the following is placed on a drive route: (i) an interaction starting condition of a point range is set, (ii) the interaction starting condition of a point range is satisfied, and (iii) there is no usage.

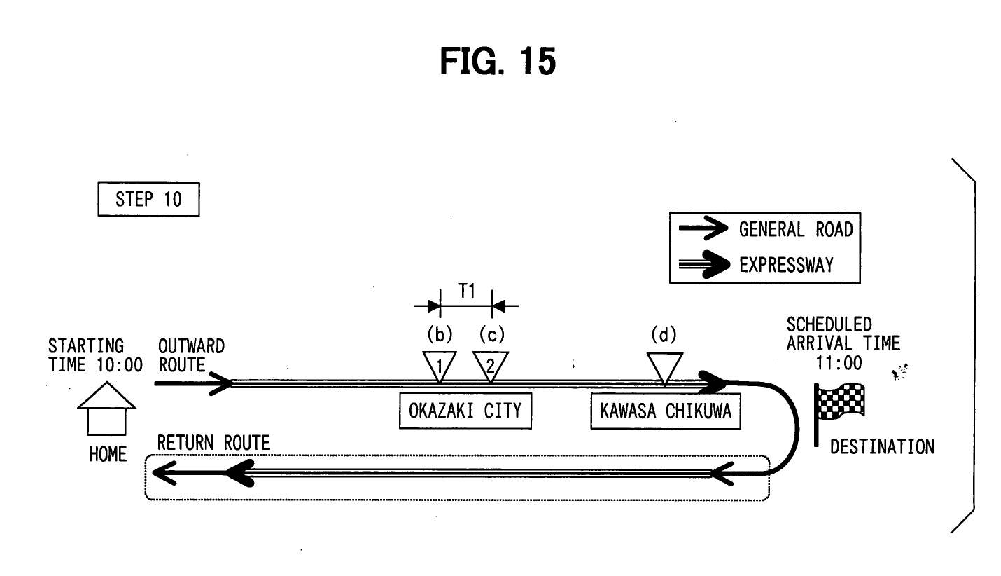

For example, in a case of the pieces of the information (a) to (d), the pieces of the information (b) to (d) are placed on a drive route in Step 10, as shown in FIG. 15. As shown in FIG. 15, since an expressway is used on an outward route of the drive route, the pieces of the information (b) to (d) are placed on the expressway as much as possible in accordance with the rule 1. The pieces of the information (b) and (c), which have the same point range, are placed in the descending order of the priority (the order (b), (c) ), and placed so that the information is pushed at time intervals of Ti second (for example, one minute).

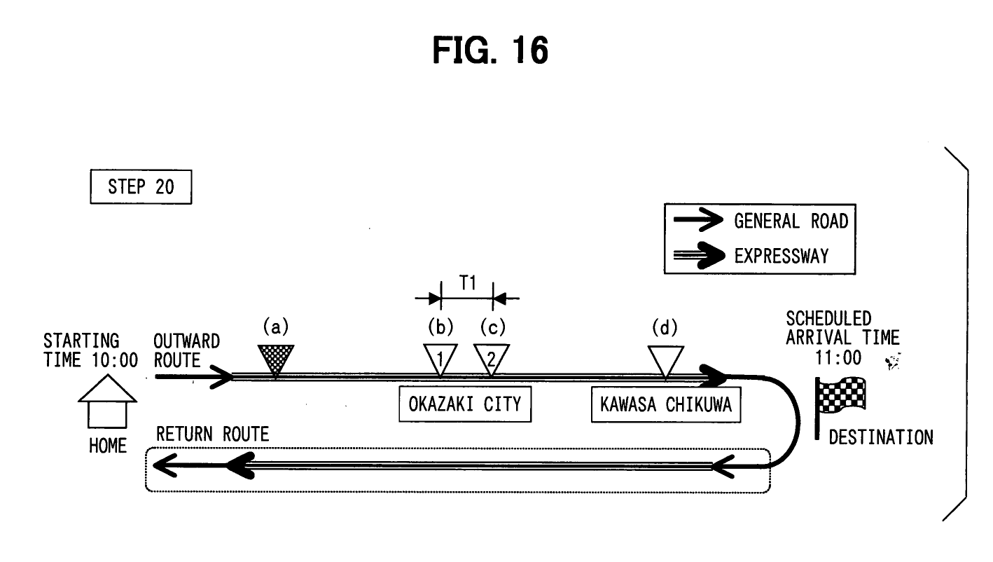

In Step 20 shown in FIG. 11, the rest guidance information in which no point range is set or an interaction starting condition of the point range is not satisfied, is placed on the drive route to satisfy a time range. For example, in a case of the pieces of the information (a) to (d), the piece of the information (a) is applied in Step 20. As shown in FIG. 16, since an expressway is used on an outward route of the drive route, the piece of the information (a) is placed on the expressway as much as possible in accordance with the rule 1. The piece of the information (a) is placed preferentially on a section where no speech interaction is executed. Accordingly, as shown in FIG. 11, the piece of the information (a) is placed before the pieces of the information (b) to (d).

Next, an interaction policy setting process in accordance with the rule 5 is explained. This process is executed during a speech interaction with a user. First, in Step 30 shown in FIG. 12, it is determined whether a user specifies a suspension and restart timing of an interaction. When the determination is positive, the process goes to Step 40, and when the determination is negative, the process goes to Step 50.

In Step 40, a current interaction is suspended, and a timing for restarting the interaction is placed to a timing specified by a user. In Step 50, it is determined whether the interaction is completed. When the determination is positive, the process is finished. When the determination is negative, the process goes to S30 to repeat the above-described process.

Next, an interaction policy setting process in accordance with the rule 6 is explained. This process is executed during an interaction with a user. First, in Step 60 shown in FIG. 13, information of a first item (or sentence) which is a subject of a current interaction is pushed. In Step 70, it is determined whether all items (or sentences) which are subjects of the current interaction are pushed.

When the determination is positive, the process is finished. When the determination is negative, a time interval for reading speeches is set in Step 80 in accordance with a workload of a user. In Step 90, the process waits until the set time in Step 80 passes. When the time passes, the process goes to Step 60 to repeat the above-described process.

Lastly, an interaction policy setting process in accordance with the rule 9 is explained. This process is executed during an interaction with a user. First, in Step 100 shown in FIG. 14, suggestion information is pushed. In Step 110, it is determined whether a user responds to the suggestion information. When the determination is negative, the process is finished. When the determination is positive, an additional explanation of the suggestion information or another suggestion information is pushed. The process goes to Step 110 to repeat the above-described process.

The navigation apparatus of this embodiment sets an interaction policy of information which satisfies an interaction starting condition in consideration of a drive route intended by a user. In accordance with the set interaction policy, information which satisfies an interaction starting condition is pushed to execute a speech interaction about the information.

Accordingly, for example, since information can be pushed at an appropriate timing in accordance with a drive route, a user does not get the impression that a speech is suddenly started. As a result, a user-friendly speech interaction can be achieved.

Alternative 1

For example, since a traffic congestion and traffic regulation suddenly happen, an interaction policy needs to be set for dynamic information such as road traffic information about the traffic congestion and traffic regulation when the dynamic information is acquired. Therefore, in an interaction policy setting process of this alternative, when dynamic information such as road traffic information is acquired by the road traffic information acquiring unit 103 as a dynamic information acquiring unit, an interaction policy including the acquired dynamic information is reset. Accordingly, a speech interaction about the dynamic information such as the traffic congestion information can be achieved.

Alternative 2

The rule 2 explained in this embodiment “at a point where a sign, a board, or a building is visible, the related information is pushed” is as follows. As well as in the rule 1, a drive route is first grasped, and guidance information which satisfies an interaction starting condition of a point range shown in FIG. 3 is extracted, and placed on the drive route.

On the other hand, in this alternative, an object information detecting unit is provided for detecting information about at least one object of a sign, a board, and a building. An interaction policy is set so that, when the object information detecting unit detects object information, information about the object is pushed and a speech interaction about the information is executed.

Accordingly, a speech interaction of information about, e.g., a sign, a board, and a building, which is not previously provided, can be executed. As well as in the embodiment, buildings may include incomplete buildings even in this alternative. Accordingly, information about the incomplete buildings can be detected.

To detect a point where an object such as a sign, a board, or a building is visible, an image recognition process apparatus for detecting objects by means of an image recognition process may be used to determine whether the object is visible. Without the image recognition process apparatus, when information about a position of an object and about a speech interaction of the object is detected, it can be determined from a current position and a position of the object whether the object is placed on a point where the object is visible. Additionally, information required for a speech interaction can be detected.

Further, information about the object can be acquired from the outside via the transmitter-receiver 11. By use of the various apparatuses, information about the object can be detected. The information about the object acquired via the transmitter-receiver 11 may be acquired using interactive communications such as a digital broadcast. The information about the object may be transmitted from signs, boards, and buildings themselves.

It will be obvious to those skilled in the art that various changes may be made in the above-described embodiments of the present invention. However, the scope of the present invention should be determined by the following claims.

What is claimed is:

1. A speech interaction apparatus that starts pushing information to a user and executes a speech interaction about the information in a case where (i) an interaction starting condition for starting pushing the information is set and (ii) the interaction starting condition is satisfied,
the speech interaction apparatus comprising:
an interaction policy setting unit for setting, in consideration of a drive route intended by the user, an interaction policy of certain information which satisfies an interaction starting condition; and
a speech interaction unit for pushing the certain information and for executing a speech interaction about the certain information in accordance with the interaction policy set by the interaction policy setting unit.

2. A speech interaction apparatus according to claim 1,
wherein the interaction starting condition relates to, with respect to information, at least one of a point range, a time range, a usage history, and a priority.

3. A speech interaction apparatus according to claim 2, further comprising:
a usage history managing unit for managing a usage history with respect to information based on an execution of a speech interaction about the information by the speech interaction unit,
wherein the interaction policy setting unit sets an interaction policy that information having no usage history is pushed.

4. A speech interaction apparatus according to claim 3, further comprising:
a user specifying unit for specifying a user,
wherein the usage history managing unit manages a usage history with respect to each user specified by the user identifying unit.

5. A speech interaction apparatus according to claim 4, wherein the user specifying unit executes a user specifying process using at least one of a face image, living body information, speech information, and a password.

6. A speech interaction apparatus according to claim 3,
wherein the usage history managing unit does not manage a usage history corresponding to time varying information which varies in a time basis.

7. A speech interaction apparatus according to claim 2,
wherein, when an outward route of the drive route includes an expressway and when there is information which satisfies the interaction starting condition both on a section of the expressway and on a section of the drive route after passing through the expressway, the interaction policy setting unit sets an interaction policy that the information is pushed on the section of the expressway.

8. A speech interaction apparatus according to claim 2, further comprising:
a road section specifying unit for specifying a road section on which a workload of a user is high,
wherein, when the drive route includes the road section, the interaction policy setting unit sets an interaction policy that only information whose priority is equal to or over a predetermined value is pushed on the road section.

9. A speech interaction apparatus according to claim 8, further comprising:
a road traffic information acquiring unit for acquiring road traffic information,
wherein the road section specifying unit specifies a high traffic road section indicated by the road traffic information as the road section on which a workload of a user is high.

10. A speech interaction apparatus according to claim 2,
wherein a range of a point in which at least one object of a sign, a board, and a building is visible is set as the interaction starting condition of the point range, and
wherein, when there is information which satisfies the interaction starting condition of the point range on the drive route, the interaction policy setting unit sets an interaction policy that information about the at least one object is pushed in the range of the point in which the at least one object is visible.

11. A speech interaction apparatus according to claim 10,
wherein the building includes an incomplete building.

12. A speech interaction apparatus according to claim 11,
wherein an interaction starting condition relating to an expiration date of the incomplete building is set, and the interaction policy setting unit sets an interaction policy that information whose expiration date has expired is not pushed.

13. A speech interaction apparatus according to claim 12,
wherein the interaction policy setting unit sets an interaction policy that related information is pushed with respect to, of information having the usage history, only information about the incomplete building having an interaction starting condition of an expiration date.

14. A speech interaction apparatus according to claim 2,
wherein the interaction policy setting unit sets an interaction policy that, on a return route of the drive route, only information that has no usage history and indicates the priority of equal to or over a predetermined value is pushed.

15. A speech interaction apparatus according to claim 2,
wherein the interaction policy setting unit sets an interaction policy that, in a case where a plurality of pieces of information exist which satisfy an interaction starting condition of a same point range on the drive route, when more than a predetermine time passes after a speech interaction of one piece of information is completed, another piece of the information is pushed, as long as an interaction starting condition of each piece of information is satisfied.

16. A speech interaction apparatus according to claim 1, further comprising:
a dynamic information acquiring unit for acquiring dynamic information on the drive route,
wherein, when the dynamic information acquiring unit acquires dynamic information, the interaction policy setting unit resets an interaction policy of information including the dynamic information.

17. A speech interaction apparatus according to claim 1,
wherein the interaction policy setting unit sets an interaction policy that, when a speech for suspending a speech interaction under execution by the speech interaction unit is made, the speech interaction under execution is suspended.

18. A speech interaction apparatus according to claim 17,
wherein the interaction policy setting unit sets an interaction policy that, when the speech for suspending the speech interaction under execution and a speech for specifying a timing for restarting the speech interaction are made, the suspended speech interaction is restarted at the specified timing.

19. A speech interaction apparatus according to claim 1,
wherein the interaction policy setting unit sets an interaction policy that, in a case where information to be pushed has a plurality of items or sentences, when a predetermined time passes after an item or sentence is pushed, an item or sentence following the pushed item or sentence is pushed.

20. A speech interaction apparatus according to claim 19,
wherein the interaction policy setting unit includes a time changing unit for changing the predetermined time in accordance with a workload of a user.

21. A speech interaction apparatus according to claim 1,
wherein the interaction policy setting unit sets an interaction policy that information for introducing a speech interaction function is pushed at a preset timing.

22. A speech interaction apparatus according to claim 1,
wherein the interaction policy setting unit sets an interaction policy that, when there is no speech of response to suggestion information pushed from the speech interaction unit to a user even after a response waiting time passes, a speech interaction of an additional explanation of the suggestion information or a speech interaction of different suggestion information from the suggestion information is executed.

23. A speech interaction apparatus that starts pushing information to a user and executes a speech interaction about the information,
the speech interaction apparatus comprising:
an object information detecting unit for detecting object information about at least one object of a sign, a board, and a building; and
a speech interaction unit for pushing certain information about the detected at least one object and for executing a speech interaction about the certain information when the object information detecting unit detects the object information.

24. A speech interaction apparatus according to claim 23,
wherein the object information detecting unit detects a position of the at least one object and information about a speech interaction of the at least one object as the object information.

25. A speech interaction apparatus according to claim 23,
wherein the object information detecting unit detects object information about the at least one object by use of at least one of (i) an image processing device for detecting an object by means of an image recognition process and (ii) a radio device for receiving information about an object from an outside.

26. A speech interaction apparatus according to claim 23,
wherein the building includes an incomplete building.

27. A speech interaction apparatus comprising:
a speech interaction unit for pushing information to a user and for executing a speech interaction about the information; and
an interaction policy setting unit for setting an interaction policy that, when a speech for suspending a speech interaction under execution by the speech interaction unit and a speech for specifying a timing for restarting the speech interaction are made by a user, the speech interaction under execution is suspended, and the suspended speech interaction is restarted at the specified timing,
wherein the speech interaction unit executes a speech interaction in accordance with an interaction policy set by the interaction policy setting unit.

28. A speech interaction apparatus comprising:
a speech interaction unit for pushing information to a user and for executing a speech interaction about the information; and
an interaction policy setting unit for setting an interaction policy that, in a case where information to be pushed includes a plurality of items or sentences, when a predetermined time passes after one item or sentence is pushed, an item or sentence following the pushed item or sentence is pushed,
wherein the speech interaction unit executes a speech interaction in accordance with an interaction policy set by the interaction policy setting unit.

29. A speech interaction apparatus according to claim 28,
wherein the interaction policy setting unit includes a time changing unit for changing the predetermined time in accordance with a workload of a user.

30. A speech interaction apparatus comprising:
a speech interaction unit for pushing information to a user and for executing a speech interaction about the information; and
an interaction policy setting unit for setting an interaction policy that a speech interaction of information which introduces a speech interaction function is executed at a preset timing,
wherein the speech interaction unit executes a speech interaction in accordance with an interaction policy set by the interaction policy setting unit.

31. A speech interaction apparatus that starts pushing information to a user and executes a speech interaction about the information in a case where (i) an interaction starting condition for starting pushing the information is set and (ii) the interaction starting condition is satisfied,
the speech interaction apparatus comprising:
a usage history managing unit for setting an interaction starting condition relating to a usage history with respect to information, and for managing the usage history of the information based on an execution of a speech interaction about the information; and
a speech interaction unit for pushing certain information having no usage history, and executing a speech interaction about the certain information.

32. A speech interaction apparatus according to claim 31, further comprising:
a user specifying unit for specifying a user, wherein the usage history managing unit manages a usage history with respect to each user specified by the user specifying unit.

33. A speech interaction apparatus according to claim 32,
wherein the user specifying unit specifies a user by executing a user specification process using at least one of a face image, living body information, speech information, and a password.

34. A speech interaction apparatus according to claim 31,
wherein the usage history managing unit does not manage a usage history corresponding to time varying information which varies in a time basis.

35. A speech interaction apparatus comprising:
a speech interaction unit for pushing information to a user, and for executing a speech interaction about the information; and
an interaction policy setting unit for, in a case where there is no speech of response to suggestion information even when a response waiting time passes after the speech interaction unit pushes the suggestion information to a user, setting an interaction policy that a speech interaction of an additional explanation for the suggestion information or a speech interaction of different suggestion information from the suggestion information is executed,
wherein the speech interaction unit executes a speech interaction in accordance with an interaction policy set by the interaction policy setting unit.

36. A speech interaction method for starting pushing information to a user and executing a speech interaction about the information in a case where (i) an interaction starting condition for starting pushing the information is set and (ii) the interaction starting condition is satisfied,
the speech interaction method comprising:
setting an interaction policy of certain information which satisfies an interaction starting condition, in consideration of a drive route intended by a user; and
pushing the certain information and executing a speech interaction about the certain information, in accordance with the set interaction policy.

37. A speech interaction method according to claim 36,
wherein the interaction starting conditions relates to, with respect to information, at least one of a point range, a time range, a usage history, and a priority.

38. A speech interaction method according to claim 37,
wherein a usage history is managed with respect to information based on an execution of a speech interaction about the information, and
wherein an interaction policy is set so that information having no usage history is pushed.

39. A speech interaction method according to claim 38,
wherein a user is specified, and a usage history is managed with respect to each specified user.

40. A speech interaction method according to claim 39,
wherein a user specifying process to specify a user is executed using at least one of a face image, living body information, speech information, and a password.

41. A speech interaction method according to claim 38,
wherein a usage history corresponding to time varying information which varies in a time basis is not managed.

42. A speech interaction method according to claim 37,
wherein, an interaction policy is set so that, when an expressway is contained in an outward route of the drive route, and when information exists which satisfies the interaction starting condition both on a section of the expressway and on a section of the drive route after passing through the expressway, the information is pushed on the section of the expressway.

43. A speech interaction method according to claim 37,
wherein an interaction policy is set so that, when a road section where a workload of a user is high is specified, and when the specified road section is contained in the drive route, only information whose priority of equal to or over a predetermined value is pushed on the road section.

44. A speech interaction method according to claim 43,
wherein road traffic information is acquired, and a high traffic road section indicated by the acquired road traffic information is specified as the road section where a workload of a user is high.

45. A speech interaction method according to claim 37,
wherein an interaction policy is set so that, when a range of a point where at least one object of a sign, a board, and a building is visible is set as the interaction starting condition of the point range, and when information exists which satisfies the interaction starting condition of the point range on the drive route, information about the at least one object is pushed in the range of the point where the at least one object is visible.

46. A speech interaction method according to claim 45,
wherein the building includes an incomplete building.

47. A speech interaction method according to claim 46,
wherein an interaction starting condition relating to an expiration date of the incomplete building is set, and
wherein an interaction policy is set so that information whose expiration date has expired is not pushed.

48. A speech interaction method according to claim 47,
wherein an interaction policy is set so that, of information having the usage history, only information about the incomplete building having an interaction starting condition of an expiration date is pushed.

49. A speech interaction method according to claim 37,
wherein an interaction policy is set so that only information having no usage history and the priority of equal to or over a predetermined value is pushed on a return route of the drive route.

50. A speech interaction method according to claim 37,
wherein an interaction policy is set so that, in a case where a plurality of pieces of information exists which satisfy an interaction starting condition of a same point range on the drive route, when more than a predetermined time passes after a speech interaction about one piece of information is completed, another piece of the information is pushed as long as an interaction starting condition of each pieces of the information is satisfied.

51. A speech interaction method according to claim 36,
wherein dynamic information on the drive route is acquired, and an interaction policy of information including the acquired dynamic information is reset.

52. A speech interaction method according to claim 36,
wherein an interaction policy is set so that, when a speech for suspending a speech interaction under execution is made, the speech interaction under execution is suspended.

53. A speech interaction method according to claim 52,
wherein an interaction policy is set so that, when a speech for suspending the speech interaction and a speech for specifying a timing for restarting the speech interaction are made, the suspended speech interaction is restarted at the specified timing.

54. A speech interaction method according to claim 36,
wherein an interaction policy is set so that, in a case where information to be pushed includes a plurality of items or sentences, when a predetermined time passes after one item or sentence is pushed, an item or sentence following the pushed item or sentence is pushed.

55. A speech interaction method according to claim 54,
wherein the predetermined time is changed in accordance with a workload of a user.

56. A speech interaction method according to claim 36,
wherein an interaction policy is set so that information which introduces a speech interaction function at a preset timing is pushed.

57. A speech interaction method according to claim 36,
wherein an interaction policy is set so that, in a case where there is no speech of response to suggestion information even when a response waiting time passes after the suggestion information is pushed to a user, a speech interaction of an additional explanation of the suggestion information or a speech interaction of different suggestion information from the suggestion information is executed.

58. A speech interaction method for starting pushing information to a user and executing a speech interaction about the information,
the speech interaction method comprising:
detecting object information about at least one object of a sign, a board, and a building; and
pushing certain information about the at least one object and executing a speech interaction about the certain information, when the object information is detected.

59. A speech interaction method according to claim 58,
wherein a position of the at least one object and information about a speech interaction of the at least one object are detected as the object information.

60. A speech interaction method according to claim 58,
wherein information about object information is detected by use of at least one of (i) an image processing device for detecting an object by means of an image recognition process and (ii) a radio device for receiving information about an object from an outside.

61. A speech interaction method according to claim 58,
wherein the building includes an incomplete building.

62. A speech interaction method in which information is pushed to a user, and a speech interaction about the information is executed,
the speech interaction method comprising:
setting an interaction policy that, when a speech for suspending a speech interaction under execution and a speech for specifying a timing for restarting the speech interaction are made by a user, the speech interaction under execution is suspended, and the suspended speech interaction is restarted at the specified timing; and
executing a speech interaction in accordance with the interaction policy.

63. A speech interaction method in which information is pushed to a user, and a speech interaction about the information is executed,
the speech interaction method comprising:
setting an interaction policy that, in a case where information to be pushed includes a plurality of items or sentences, when a predetermined time passes after one item or sentence is pushed, an item or sentence following the pushed item or sentence is pushed; and
executing a speech interaction in accordance with the interaction policy.

64. A speech interaction method according to 63,
wherein the predetermined time is changed in accordance with a workload of a user.

65. A speech interaction method in which information is pushed to a user, and a speech interaction about the information is executed,
the speech interaction method comprising:
setting an interaction policy that information which introduces a speech interaction function at a preset timing is pushed; and
executing a speech interaction in accordance with the interaction policy.

66. A speech interaction method for starting pushing information to a user and executing a speech interaction about the information in a case where (i) an interaction starting condition for starting pushing the information is set and (ii) the interaction starting condition is satisfied,
the speech interaction method comprising:
setting an interaction starting condition relating to a usage history with respect to information;
managing the usage history corresponding to the information based on an execution of a speech interaction about the information; and
pushing certain information having no usage history and executing a speech interaction about the certain information.

67. A speech interaction method according to claim 66,
wherein a user is specified, and a usage history is managed with respect to each user.

68. A speech interaction method according to claim 67,
wherein a user specifying process to specify a user is executed using at least one of a face image, living body information, speech information, and a password.

69. A speech interaction method according to claim 66,
wherein a usage history corresponding to time varying information which varies in a time basis is not managed.

70. A speech interaction method in which information is pushed to a user, and a speech interaction about the information is executed,
the speech interaction method comprising:
setting an interaction policy that, in a case where there is no speech of response to suggestion information even when a response waiting time passes after the suggestion information is pushed to a user, a speech interaction of an additional explanation of the suggestion information or a speech interaction of different suggestion information from the suggestion information is executed; and
executing a speech interaction in accordance with the set interaction policy.
